(19) United States
(12) Patent Application Publication
(10) Pub. No.: US 2008/0115197 A1
(43) Pub. Date: May 15, 2008

(54) System and apparatus for digital rights management of content and accessibility at various locations and devices

(76) Inventor: Barrie Jon Moss, Cumbria (GB)

Correspondence Address: REED SMITH, LLP, TWO EMBARCADERO CENTER, SUITE 2000, SAN FRANCISCO, CA, 94111, US

(21) Appl. No.: 11/599,240

(22) Filed: Nov. 14, 2006

(51) Int. Cl. G06F 7/04; G06Q 30/00

(52) U.S. Cl. 726/4; 705/26

(57) ABSTRACT

An active virtual environment for the identification and distribution of content and other resources according to digital rights. A network of brokers manage and provide access to a nodes containing virtualized set of resources and services. The resources and services are granted to requesting users who have appropriate licensed rights (or have accounts sufficient to pay for those rights upon request). A digital rights manager is configured to approve requests based on existing rights and/or approve request based on an appropriately configured account with sufficient balance or credit to acquire those rights when requested. The user requests are made from user devices connected to a world-wide network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to the management of digital rights and more particularly to the management of digital rights through the use of brokers and tokens.

2. Discussion of Background

Digital rights are becoming increasingly important as digital media and accessibility via the Internet and networks formed by wireless communications between different devices and different device types. The content environment consists of a set of resources and a set of services which can act upon those resources, for example an MP3 file and a player that can process that MP3 file into audio output for listening.

Current architectures are “possession” based, which means that if a consumer possesses a resource, they can do what they like with it, irrespective of whether they are legally entitled to do so. The nature of possession based architectures also bind a resource to the device upon which it is physically located. For example, if a song is downloaded to a digital music player, the customer cannot listen to the song on another device.

### SUMMARY OF THE INVENTION

The present inventor has realized the need for greater accessibility to content. The content may be accessible any number of devices based on a license or restrictions imposed by the content owner. Some devices may also have restrictions imposed on the types of content they may utilize.

Roughly described, the present invention provides a digital rights management system, where a user (content user) can access to content (e.g., music, movie, news clip, etc.) from any location/device which has appropriate licenses. In other words, instead of tying a piece of content to you by means of putting it on a machine or storage mechanism (e.g., DVD, CDROM, memory card, etc), the user accesses the content from any machine enabled by a system implementing the present invention so long as the user has the appropriate license(s). This prevents piracy of content and reduces the load associated to a user who currently have to find a method to take the content “with them” on some device.

The above is important to various embodiments and supports a goal for digital content availability on any digital device. Further, such functionality can enhance the implementation of a video news service from a legal standpoint. The present invention provides the ability to distribute content to a customer's various devices and a distributor would utilize digital rights management to make it happen.

In one embodiment, the present invention provides a rights based architecture, comprising, a digital rights manager configured to receive and approve requests for content from remotely connected users, at least one node comprising a virtualized set of content available to fulfill requests, at least one virtual mart associated with the nodes comprising a virtual marketplace for fulfilling requests, and a dynamic network of brokers configured to identify and deliver content requests approved by the digital rights manager.

In other embodiments the present invention may also be embodied as a device, apparatus, or system. For example, in one embodiment, the present invention is a system, comprising, a set of resources, and a set of systems configured to act upon the resources, wherein the set of resources and the set of systems are available for use by users having an appropriate rights set to use a particular resource requested by the user. In one embodiment, the system comprises a rights based architecture including a rights manager configured to verify a users right to a resource before communicating the resource to the user, and the resources comprise any of digital content including entertainment, news, sports, etc.

The present invention includes a method of digital rights management, comprising the steps of, receiving a request for access from a user, comparing the access request to a set of rights owned by the user, and authorizing the requested access if the user owns appropriate rights for the access.

Portions of any of the device, architecture, system, and/or method may be conveniently implemented in programming on a general purpose computer, or networked computers, and the results may be displayed on an output device connected to any of the general purpose, networked computers, or transmitted to a remote device for output, or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is block diagram of a digital rights management system according to an embodiment of the present invention;

FIG. 2 is an illustration of an architecture and system according to an embodiment of the present invention;

FIG. 3 is an illustration of an example set of public rights sets associated with individual users according to an embodiment of the present invention;

FIG. 4 is an illustration of physical devices implementing an example virtual environment according to an embodiment of the present invention; and

FIG. 5 is a flow chart of a rights management process according to an embodiment of the present invention.

### DESCRIPTION OF THE PREFERRED EMBODIMENTS

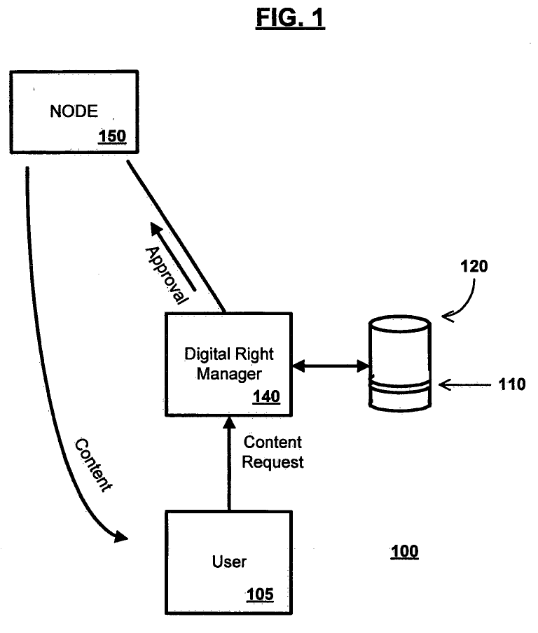

Referring now to the drawings, wherein like reference numerals designate identical or corresponding parts, and more particularly to FIG. 1 thereof, there is illustrated a digital rights management system 100 according to an embodiment of the present invention. In a content environment built on a rights based architecture, the user 105 is at the centre of the solution. The user 105 makes requests (e.g., content request 130) to perform one or more actions against one or more resources 150. The resources may include, for example, movies (iPOD/handheld device quality movies, HDTV quality movies, music, news, sports, game pieces, ammunition for game pieces, etc).

A rights manager 140 checks each request against the user's rights set 110. The user's rights set 110 is the set of rights granted to the user and may be stored along with other users' rights in, for example, a database 120. If user has the right to perform a certain action then the system proceeds with executing that action (e.g., sends clearance to resource 150 to provide the requested content to user 150).

Other variations of the content request and grant may be implemented. For example, the user's content request 130 may be directed to the resource, and then the resource forwards the request to the rights manager for clearance before proceeding with the distribution.

Regardless of the procedure used for clearance, in a rights based system the emphasis is on the ‘right’ to perform an action, which can include such things as being allowed to be aware of a resource, experience and manipulation of a resource to the ability to also grant rights.

In one embodiment, the system is implemented in a virtual environment. When the system is implemented in a virtual environment, the resources and services (e.g., resources 150 may include services such as buying services, photo printing orders, or any type of e-commerce) are available in the virtual environment. The actual physical location of the resources and services is transparent to the user. The user's experience of the rights based content environment is that the user makes a request to perform an action, and, if the user has the appropriate right, then the action is performed.

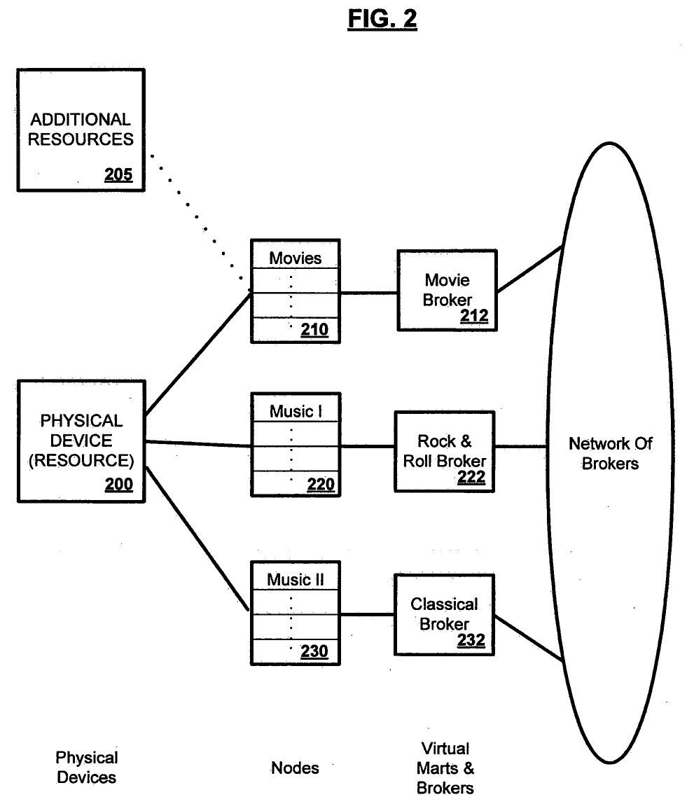

In one embodiment, each physical device within the system supports one or more “nodes”. A node is a virtualised set of resources and services extracted from the physical device. For example, FIG. 2 is an illustration of an architecture including a physical device 200 in a system according to an embodiment of the present invention. The physical device 200 is, for example, a repository of digital content including movies and various genres of music. In the illustrative example, physical device 200 is shown to support 3 nodes, comprising a virtual movie collection 210, a virtual rock & roll collection 220, and a virtual classical music collection 230.

Each node is managed by an agent called a “broker”, which creates a “virtual market” or “virmart”, that is local to the node. Virtual Mart 210A and its corresponding broker manages a virtual mart for the licensed distribution of resources managed by the movie node 210. Virtual Mart 220A and its corresponding broker manages a virtual mart for the licensed distribution of resources managed by the rock & roll node 220. Virtual Mart 230A and its corresponding broker manages a virtual mart for the licensed distribution of resources managed by the classical music node 230.

Any number of nodes and virtual marts may ultimately be supported by a single physical resource. The examples provided are general in nature and themselves my be subdivided further into more specific nodes with corresponding virtual marts. For example, the classical music node may support sub-nodes of certain orchestras performing classical pieces, such as the London Philharmonic or Boston Pops. Any number of categories or organizational divisions may be made.

Within the virtual realm, a node may also communicate with additional physical resources to supplement available resources. In this example, the virtual movie collection node is illustrated as communicating with an additional node 205 from which additional resources are made virtually available.

A single broker can then make use of communications services supported by its host device to contact other brokers, forming a dynamic network of brokers. This in turn becomes the active virtual environment. The network of brokers provide the path by which the content or other resource requests are made and fulfilled (e.g., all paths for requests and fulfillment arriving or departing from either nodes or virtual marts are made through the network of brokers). The active virtual environment provides in its capability set the sum of the capability sets of each member node.

Each broker offers a “public rights set.” This is a set of rights available to any user and represents the resources and services available in that node without any restriction to any user. In addition, a user uniquely has a “private rights set”. This set of rights is collected by the user through a variety of means, perhaps the creation of a document or the purchase of a song.

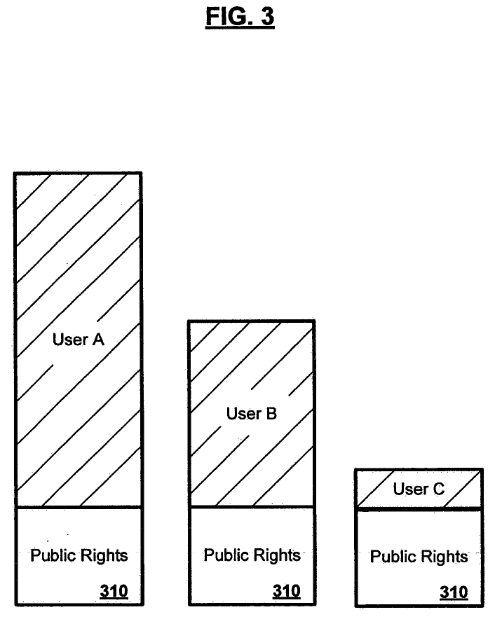

A user's total rights set is the sum of the public rights sets of all member nodes of the active virtual environment plus their own private rights set. FIG. 3 is an illustration of an example public rights set 310 possessed by each of users A, B, and C. Each users' rights set is then supplemented with the user's individually owned private rights set 312A, 312B, and 312C, respectively.

A user in the physical world enters the virtual world using a digital device—called the ‘accessor’. The accessor includes the ability to host some form of interactive environment and a means of communicating with, and becoming part of the active virtual environment. The accessor is, for example, a handheld device such as a cell phone, PDA, ipod, WIFI enabled device, home computer, etc. The accessor is responsible for matching up the physical user with their virtual presence—called the Virtual Interactive Persona (VIP).

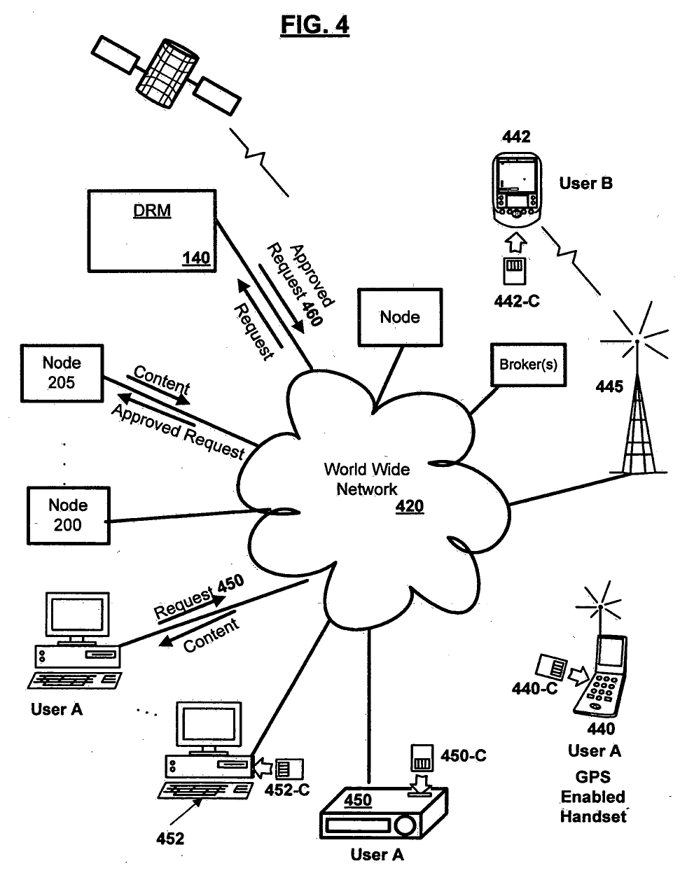

A physical user can have one or more VIPs. For example, FIG. 4 is an illustration of physical devices implementing an example virtual environment according to an embodiment of the present invention. User A is the owner of physical devices: cell phone 440, set-top box 450, and general purpose computer 455. User B is owner of physical devices: PDA 442 and personal computer 452. Many other devices may be utilized to provide VIPs, including appropriately provisioned ipods, DVD players, and other electronic devices or programs running on a general or specialized computer system. In one embodiment, the device runs a device independent operating system such as Amiga Anywhere™, and other programs necessary for implementing and/or making requests. Such operating systems and programs are, for example, distributed electronically over wireless networks to the devices or stored on pre-burned storage cards (e.g., card 442-C) inserted into the device.

Each VIP has its own mode of communication to remain in contact with the network of devices and brokers implemented by the present invention. The network is, for example, a private, secure communications network. However, preferably, the network may be implemented as a secure network operating on a world-wide general purpose network, such as the Internet.

Each broker includes a selection process smart enough to use any available connectivity to find other brokers. For example in a home network with a DSL router, a PDA may get a movie from a home server rather than going out onto the internet to get it. Thus, the broker is set up to select local or preferred, or search local or preferred resources for other brokers prior to engaging remote resources.

The accessor interactive environment invokes a VIP service, which attempts to locate and access a VIP object. This may be local or remote. In one embodiment, if the VIP object access attempt fails, a ‘guest’ object is created which grants to the user the “public rights set”.

Once the physical user is driving a VIP, they can then request actions available in their active rights set. Any request is first checked against the active rights set. This may be a static check or could extend to a dynamic check. A dynamic check involves the request being verified against a granting resource.

Indeed the permission checking could be a multi step process. For example if a parent buys a family right to watch a film, that would need to be checked out over the Internet and then a child in the family may want to watch it, and that would need to be checked both with the initial right (parent purchase) and any family right granted by the parent to the family members in the local network. Such viewing rights may be granted and then viewing codes provided to a set-top box (e.g. cable-box, DVD player, etc) to be used in combination with an interface to a display e.g. an HDMI interface to a television.

In order to accumulate rights, there is a two way relationship between the granter of the right and the grantee. For example, if person A creates a picture and person B wants to view it, then person A has to grant that right to person B.

This right can not only be checked during the request phase of an action but also through the execution phase of an action, for example ten minutes into playing a video clip. Such ‘dynamic confirmation’ of a right allows for a much more secure distribution and experience model.

A rights based content environment is user centric. It is about serving experience to a user. As an example, consider a user purchasing the right to listen to a specific song. The nature of this right is enshrined in a contract and could include (but is not limited to) unlimited listening of the song, listening to it for a period of time or listening to it a number of times. That right is granted to the user and is placed in their private rights set.

Although the invention is directed mainly to allow the provision of content anytime and anywhere according to the user's rights set, in one embodiment the user's rights set is yet further limited. For example, a rights set may limited such that certain content may only be accessed by a specific device. For example, the user may have purchased the right to listen to a song or other content, but only in conjunction with a certain physical device.

Further, restrictions may include, use or access to content when the user is within boundaries. For example, access or use of certain content may be prohibited in certain areas of the world, or only accessible in selected countries, states, cities, or even locations within a city. Location restrictions are be implemented via position verification of the physical device on which the content is to be provided. For example, if a user requests a certain content having access restrictions based on location, the response can be a request for further information, namely location in this example. The location information can be provided by user entry of the location (zip code, for example) , or preferably via an automatic location reply from a Global Positioning System (GPS) unit in the physical device.

In one embodiment, position information is transmitted at logon, and updated as a user travels. All content listings from which the user may select content is then automatically edited based on any restrictions or special features for the user's location. For example, a public or private event may include special broadcasts that are only to be made available to those within the venue which the event is taking place (e.g., broadcasts or special commentary available to those physically at a sporting event). Users may or may not have needed to sign up for such broadcasts, but the location restriction works such that a user cannot receive the broadcast unless they are physically located within the stadium or other venue where the event takes place.

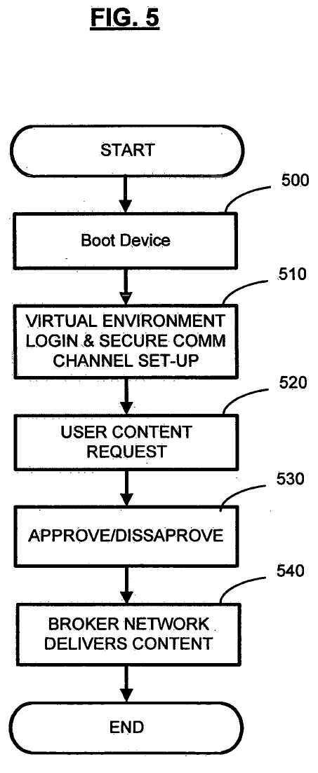

In one embodiment, a process according to the present invention is described in FIG. 5. At step 510, an accessor boots an interactive environment and invokes a VIP service. Secure communications between the accessor, nodes, and Digital Rights Management facilities (e.g., device 445, nodes 205/210, and Digital Rights Manager (DRM) 140, for example) are-set up as needed. At step 520, a request (e.g., initial request 450) is sent to the DRM 150. The request is, for example, a request for previously licensed content (e.g., song, movie, etc.), or a request to view a listing of available content. The request may also be for publicly available content, or for unlicensed content for which a user may have a credit or pre-paid account to apply against the cost of any needed licenses. The users rights are checked against the rights database, and an approval (e.g., approved request 460) is generated. The approved request is then handled by a broker who then finds the content through the network of brokers. The content is then delivered to the requesting user.

In one embodiment, the delivered content is direct delivery of digital data from the node maintaining the content in storage (e.g., in a local memory or a database, for example). In another embodiment, the delivery may be a key or encryption code that allows the user's device to decrypt a publicly accessible but encrypted file, set of data, streaming broadcast, etc. In yet another embodiment, the available node from which brokers may find data can include other users devices that are made available to the network. Thus the most efficient path for content delivery is utilized.

When the user enters the virtual environment and drives a VIP, they can request execution of that right. The right will be verified (including rights to the content, device, and location, if applicable). The request will then be executed.

In our example, the request to listen to a song will lead to an activity service attempting to procure the actual resource, the song object itself. The procurement service will ask the broker if the song object is available in the local market. If so, it will use it. If not, the broker will then ask other brokers if they have the song object and it will be transferred to the local market (and thus local device) for the duration of the activity.

Since a user can enter the virtual environment from anywhere at anytime using any device, they can listen to that song at will without restriction so long as they own the appropriate rights.

In one embodiment, the active virtual environment active user's rights set and environment initiated by the VIP will always be limited to the node member set and thus that particular capabilities set.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a database, memory, broker, etc., any other equivalent device or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to communication channels, content, keys, handheld and/or desktop devices, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW±, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, establishing virtual environments, communicating requests and approvals for content, transporting content, maintaining users' rights lists, checking rights packages, establishing outside parameters for evaluating rights (e.g., location), and the display, storage, or communication of results according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A rights based architecture, comprising:
a digital rights manager configured to receive and approve requests for content from remotely connected users;
at least one node comprising a virtualized set of content available to fulfill requests;
at least one virtual mart associated with the nodes comprising a virtual marketplace for fulfilling requests; and
a dynamic-network of brokers configured to identify and deliver content requests approved by the digital rights manager.

2. The rights based architecture according to claim 1, further comprising a database of user rights; wherein the digital rights manager compares requests from a user against the user's rights in the database in approving content requests.

3. The rights based architecture according to claim 2, wherein the database of user rights includes licensed rights owned by the user.

4. The rights based architecture according to claim 2, wherein the database of user rights includes rights to the requested content restricted according to one or more of time of use, number of repetitions, location of the user, and device on which the content may be played.

5. The rights based architecture according to claim 1, wherein the dynamic network of brokers comprises a broker associated with each virtual mart and capable of using communication channels on a physical device hosting the virtual mart's corresponding node to communicate with other brokers in an active virtual environment for locating and transmitting the content.

6. A system, comprising:
a set of resources;
a set of systems configured to act upon the resources;
wherein the set of resources and the set of systems are available for use by users having an appropriate rights set to use a particular resource requested by the user.

7. The system according to claim 6, wherein the system comprises a rights based architecture including a rights manager configured to verify a users right to a resource before communicating the resource to the user.

8. The system according to claim 7, wherein the resources comprise entertainment content.

9. The system according to claim 6, further comprising:
a series of nodes comprising virtualized set of at least a portion of the resources;
a virtual market corresponding to at least one of the nodes configured to provide virtual access to the resources; and
a network of brokers configured to find and communicate the resources.

10. The system according to claim 9, wherein each virtual market is associated with at least one broker using communication channels of a device hosting the virtual mart to communicate with other brokers in an active virtual environment configured to facilitate identification and distribution of the resources.

11. The system according to claim 10, wherein the resources comprises digital media content licensed for distribution to a user when played on an approved user device.

12. A method of digital rights management, comprising the steps of:
receiving a request for access from a user;
comparing the access request to a set of rights owned by the user; and
authorizing the requested access if the user owns appropriate rights for the access.

13. The method according to claim 12, wherein the set of rights owned by the user comprises a license for the requested access.

14. The method according to claim 13, wherein the requested access is access to copyrighted content.

15. The method according to claim 13, wherein the requested access is access to digital media content.

16. The method according to claim 13, wherein the requested access comprises a key to encrypted content.

17. The method according to claim 12, wherein the step of authorizing the requested content comprises locating a broker and authorizing the broker to find and deliver content associated with the requested access to the user.

18. The method according to claim 12, wherein the step of comparing comprises comparing legal rights including,
a user's license to content associated with the access,
a user's license for using the content on a user's device, and
legality of the content at a location from which the access request is initiated.

19. A computer readable media and a set of instructions stored by the computer readable media that, when loaded into a computer, cause the computer to perform the steps of claim 12.

20. The method according to claim 19, wherein said computer instruction are compiled computer instructions stored as an executable program on said computer readable media.
